(19) United States
(12) Patent Application Publication
(10) Pub. No.: US 2024/0375379 A1
(43) Pub. Date: Nov. 14, 2024

(54) A FOOD GRADE MULTILAYER FILM STRUCTURE FOR THE MANUFACTURING OF FLEXIBLE CONTAINERS OR FLEXIBLE PARTS OF CONTAINERS FOR DRY TO SEMI-LIQUID PRODUCTS

(71) Applicant: PACK2EARTH, S.L., BARCELONA (ES)

(72) Inventors: Amparo VERDÚ SOLÍS, PATERNA (ES); Maria José JIMÉNEZ PARDO, PATERNA (ES); Miriam GALLUR BLANCA, PATERNA (ES)

(73) Assignee: PACK2EARTH, S.L., BARCELONA (ES)

(21) Appl. No.: 18/692,206

(22) PCT Filed: Sep. 1, 2022
(86) PCT No.: PCT/EP2022/074301

§ 371 Date: Mar. 14, 2024

(30) Foreign Application Priority Data
Sep. 15, 2022 (EP) 21382832.0

(51) Int. Cl. B32B 23/04; B32B 7/12; B32B 23/20

(52) U.S. Cl. CPC B32B 23/04; B32B 7/12; B32B 23/20; B32B 2250/02; B32B 2307/31; B32B 2307/412; B32B 2307/546; B32B 2307/558; B32B 2307/582; B32B 2307/7163; B32B 2307/7244; B32B 2307/7246; B32B 2307/7376; B32B 2307/746; B32B 2307/748; B32B 2439/70

(57) ABSTRACT

The invention relates to a food grade multilayer film structure (10) for manufacturing flexible containers or flexible parts of containers for dry to semi-liquid products, characterized by consisting of:
a first layer (1) of a cellulose-based barrier film with a thickness between 17 and 23 μm;
a second layer (2) of a bio-based Poly(butylene succinate-co-butylene adipate) (PBSA) with a thickness between 80 and 85 μm; and
an adhesive layer (3) joining the first layer (1) and the second layer (2),
   wherein the multilayer film structure (10) is a compostable according to the European standard EN 13432.

### TECHNICAL FIELD OF THE INVENTION

The present invention relates to a food grade multilayer film structure for manufacturing flexible containers or flexible parts of containers for dry to semi-liquid products, such as pouch-like containers, doypacks and flexible lids of tubs. The invention also relates to the use of said food grade multilayer film structure for manufacturing a flexible container, as well as to the flexible container for dry to semi-liquid food products made with it.

### BACKGROUND OF THE INVENTION

Dispensing containers are well-known in a variety of industries for dispensing various liquid, semi-liquid and pasty products, such as beverages, condiments, shampoo or lotion. In particular, dispensing containers for beverages, especially conceived for sportspeople, have historically been formed by upright bottles having twist-up closures and later, flip-top closures to make their opening easier by using one hand.

The considerable volume of such bottles may not be a problem for cyclists, but it is for runners, for example, who have to carry the container themselves on the go. Pouch-like containers solve this problem because the container includes a flexible body defining a chamber made up of at least two opposed thermoplastic sheets heat sealed along its sides and the bottom for holding the liquid, semiliquid or pasty, with a dispensing closure attached to an open upper end.

As consumers become more aware of the negative effects of plastic on the environment, they are demanding environmentally friendly and sustainable packaging in order to reduce to the consumption of plastic. Thus, eco-friendly packaging alternatives such as compostable bags and home compostable packaging have been developed. However, it must be taken into account that some of that eco-friendly packing has not yet been able to reach the same level of mechanical properties and preservation of the contained product as in flexible plastic containers.

Thus, an aim of the present invention is to provide a food grade material suitable for manufacturing flexible containers for semi-liquid products that has improved mechanical properties to contain dry to semi-liquid products, that preserves the food product for a longer time in comparison to other eco-friendly flexible packaging or containers and that is compostable, preferably home compostable. Compostable and home compostable materials are types of biodegradable materials. Home compostable materials can be discarded either in city organic waste bins with other organic waste such as potato peel or can be composted in home composters and they have to degrade into toxin-free compost in under 12 months.

### DESCRIPTION OF THE INVENTION

With the aim of providing a solution, a food grade multilayer film structure for manufacturing flexible containers, or a flexible part of a container, for dry to semi-liquid products is made known. The multilayer film structure is characterized by consisting of:
a first layer of a cellulose-based barrier film with a thickness between 17 and 23 μm;
a second layer of a bio-based Poly(butylene succinate-co-butylene adipate) (PBSA) with a thickness between 80 and 85 μm; and
an adhesive layer joining the first layer and the second layer,

wherein the multilayer film structure is a compostable laminate according to the European standard EN 13432.

The requirements for the industrial compostability of packaging are set out in the European standard EN 13432. Materials and products complying with this standard can be certified and labelled accordingly.

Examples of flexible containers for dry to semi-liquid products are pouch-like containers and doypacks. An example of a flexible part of a container may be a flexible lid of a tub.

According to a preferred embodiment, the first layer has a thickness between 18.8 and 19.4 μm, preferably 19.0 μm, and the second layer has a thickness of 84 μm.

According to another characteristic of the invention, the food grade multilayer film structure has an Oxygen Transmission Rate (OTR) between 5.94 and 6.17 cm³/m²·day at 23° C. and 50% relative humidity over 24 hours according to the guidelines of ASTM D3985-17 standard, and a Water Vapour Transmission Rate (WVTR) between 10.12 and 11.46 g/m²·day at a temperature of 38° C. and 90% of relative humidity according to the guidelines of ASTM F1249-13 standard.

Another feature of the food grade multilayer film structure is that it has a puncture resistance of 14.10±1.10 N, and a tear resistance of 11.03±1.69 N, a Young Modulus of 1.34±0.07 Gpa, an elongation at break of 17.46±1.15%, a resistance to delamination of 0.108±0.005 N/mm and a dynamic coefficient of friction (COF) of 0.341±0.016 according to ISO 8295-05 standard.

TÜV AUSTRIA is a well-known certification body authorized by European Bioplastics and awards a Seedling logo to products that are in compliance with EN 13432. By awarding both the OK compost INDUSTRIAL and the Seedling logo, TÜV AUSTRIA's certificate holders have a way to give their compostable products recognition throughout the entire European market.

According to TÜV AUSTRIA's website, packaging or products featuring the OK compost INDUSTRIAL label are guaranteed as biodegradable in an industrial composting plant. This applies to all components, inks and additives. The sole reference point for the certification program is the harmonized EN 13432: 2000 standard: in any event any product featuring the OK compost INDUSTRIAL logo complies with the requirements of the EU Packaging Directive (94/62/EEC).

Besides the OK compost INDUSTRIAL label, TÜV AUSTRIA has developed OK Compost HOME label to guarantee complete biodegradability in the light of specific requirements, even in a garden compost heap. Products that are solely OK compost INDUSTRIAL-certified are those that compost only in industrial composting facilities, at temperatures between 55 to 60° C., so products that are solely OK Compost INDUSTRIAL-certified should not go into the garden compost. On the other hand, OK Compost HOME refers to products that also compost at lower temperatures, so they can go into the compost heap in your garden at home, hence the title “HOME”.

Thus, in the present specification or description, if a material, product or package is indicated to be “home compostable”, it means that it accomplishes with the requirements to hold the OK Compost HOME certification by TÜV AUSTRIA.

Preferably, the second layer of a bio-based Poly(butylene succinate-co-butylene adipate) of the multilayer film structure of the invention is home compostable.

According to another embodiment, not only the second layer, but the whole the multilayer film structure is home compostable.

Advantageously, the first layer of a cellulose-based barrier film of the food grade multilayer film structure according to the invention is printable. Thus, the food grade multilayer film structure may comprise at least one application of ink on the face of the first layer facing the adhesive layer. Printing on said face avoids the need of applying an additional cover layer at a later stage.

The second layer of a bio-based Poly(butylene succinate-co-butylene adipate) (PBSA) may also be printable so that it may comprise at least one application of ink on the face of the second layer facing the adhesive layer.

According to a further preferred embodiment of the invention, the first layer of a cellulose-based barrier film is made of a transparent cellulose film provided with an upper moisture barrier heat-seal coating and a lower moisture barrier heat-seal coating, having an Oxygen Transmission Rate (OTR) about 5.0 cc/m²·day at 23° C. and 50% relative humidity over 24 hours according to the guidelines of ASTM F 1927 standard, and a Water Vapour Transmission Rate (WVTR) about 20.0 g/m²·day at a temperature of 38° C. and 90% of relative humidity according to the guidelines of ASTM E96 standard.

According to a second aspect of the invention, it is disclosed a use of the food grade multilayer film structure that has been previously disclosed for the manufacture of a flexible container or of a flexible part of a container, for dry to semi-liquid products. The first layer of a cellulose-based barrier film may be used as the outer layer of the flexible container or of the flexible part to be manufactured and the second layer of a bio-based Poly(butylene succinate-co-butylene adipate) (PBSA) as the inner layer to be in contact with a dry to semi-liquid product. However, according to another option, the first layer of a cellulose-based barrier film may be used as the inner layer to be in contact with a dry to semi-liquid product, and the second layer of a bio-based Poly(butylene succinate-co-butylene adipate) (PBSA) may be used as the outer layer of the flexible container or of the flexible part of a container.

According to a third aspect of the invention, it is disclosed a flexible container for dry to semi-liquid products made of the food grade multilayer film structure that has been previously disclosed. In relation to a first embodiment of said flexible container, the first layer of a cellulose-based barrier film is the outer layer of the flexible container and the second layer of a bio-based Poly(butylene succinate-co-butylene adipate) (PBSA) is the inner layer to be in contact with a dry to semi-liquid food product. However, in relation to a second embodiment of said flexible container, the first layer of a cellulose-based barrier film is the inner layer to be in contact with a dry to semi-liquid product, and the second layer of a bio-based Poly(butylene succinate-co-butylene adipate) (PBSA) is the outer layer of the flexible container.

The food grade multilayer film structure is preferably manufactured following a process comprising the steps of extruding a layer of a bio-based Poly(butylene succinate-co-butylene adipate) (PBSA) with a thickness between 80 and 85 μm, preferably 84 μm; optionally printing with OK home inks a layer of a cellulose-based barrier film with a thickness between 17 and 23 μm, preferably with a thickness between 19.0 and 19.4 μm; laminating the extruded obtained layer of PBSA on the mentioned (optionally printed) film of the cellulose-based barrier film using a TÜV OK Home Compost adhesive, letting the composition cure for 24 hours before cutting and additional 24 h before using in packaging.

### BRIEF DESCRIPTION OF THE DRAWINGS

In the attached drawings, a preferred embodiment of the food grade multilayer film structure for the manufacture of flexible containers or flexible parts of containers, for dry to semi-liquid products which is an object of the invention is illustrated in an exemplary and non-limiting manner. In said drawings:

FIG. 1 is a schematic exploded view of a transversal cross section of the food grade multilayer film structure for the manufacture of flexible containers for dry to semi-liquid products of the invention;

FIG. 2 is a scheme of a barrier properties measure cell, wherein each equipment has two cells;

FIG. 3 shows the preparation of the samples with a suitable surface area to measure the barrier properties;

FIG. 4 shows the Testometric M350-20CT equipment to determine tensile resistance;

FIG. 5 shows the filling test of semi-liquids in the last batch of tested flexible containers;

FIG. 6a shows feed-block and die flow;

FIG. 6b shows a possible structure arrangement (3 non-symmetrical and 5 symmetrical structures); and

FIG. 7 is a semi-industrial RK laminating machine.

### DETAILED DESCRIPTION OF THE DRAWINGS

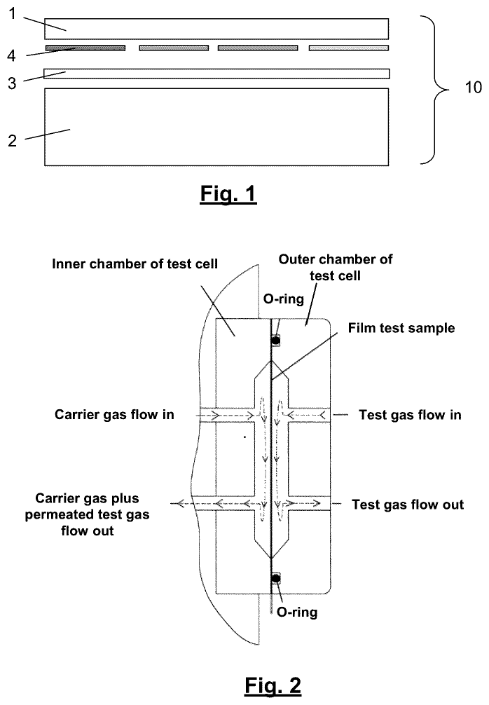

FIG. 1 shows a schematic exploded view of a food grade multilayer film structure 10 for manufacturing flexible containers or flexible parts of containers, for dry to semi-liquid products comprising:
a first layer 1 of a cellulose-based barrier film with a thickness between 17 and 23 μm, preferably with a thickness between 19.0 and 19.4 μm;
a second layer 2 of a bio-based Poly(butylene succinate-co-butylene adipate) (PBSA) with a thickness between 80 and 85 μm, preferably of 84 μm; and
an adhesive layer 3 for joining the first layer 1 and the second layer 2,
   wherein the multilayer film structure 10 is a compostable and/or biodegradable laminate according to the European standard EN 13432.

The food grade multilayer film structure 10 is suitable for manufacturing flexible containers for dry to semi-liquid products, such as doypacks and pouch-like containers comprising a flexible body having a top and a bottom ends and at least two sides defining a chamber for holding a dry to semi-liquid product, being provided with a dispensing closure attached to an open end (the top or the bottom end). The flexible body is constructed from two flexible sheets made of the food grade multilayer film structure 10, being the second layer 2 of each flexible sheet the inner layer, that is to say, the one that is in contact with the dry to semi-liquid product, whereas the first layer 1 is the outer one and can be printed to apply on its inner face patterns, signs or text in suitable ink (biodegradable and allowed for packaging and or food grade packaging, depending on the nature of the product to be packaged). Said sheets are sealed along a peripheral seal extending from the dispensing closure to the sides and the opposite end of the dispensing closure.

According to a preferred embodiment, the first layer 1 of a cellulose-based barrier film is made of a film commercially known as NatureFlex™ NK19. The film NatureFlex™ NK19 is a transparent cellulose film provided with an upper moisture barrier heat-seal coating and a lower moisture barrier heat-seal coating. NatureFlex™ NK19 is a transparent high barrier heat-sealable compostable film based on renewable resources, certified as compostable in both industrial and home composting environments, also suitable for anaerobic digestion, an excellent moisture barrier, heat sealable on both sides, formulated for enhanced print and conversion receptivity, having an excellent transparency and gloss, with excellent dead-fold characteristics, inherent anti-static properties, controlled slip characteristics, being able to act as an excellent barrier to gases and aromas and is resistant to oils and grease.

With regard to the application of NatureFlex™ NK9, it is relevant that the incorporation of a minimal amount of PVdC to optimise moisture and gas barrier functionality allows for simpler and lighter packaging to extend and maintain the shelf life of the packaged products. The film maintains good conversion receptivity as well as heat-sealability on both sides. Target applications include twist-wrap, VFFS, overwrap, flow-wrap and lamination for moisture sensitive products.

Technical Properties (typical values) of NatureFlex™ NK19 are shown in Table 1 according to manufacturer FUTAMURA.

TABLE 1

| | Test | Test | | | |
|---|---|---|---|---|---|
| Property | Basis | Conditions | Units | | NK19μ |
| Thickness | Manufacturer | | Micron | | 19.4 |
| | Test | | | | |
| Yield | Manufacturer | | m²/kg | | 35.7 |
| | Test | | g · m² | | 28.0 |
| Permeability to: | | | | | |
| Water vapour | ASTM E96 | 38° C. 90% RH | g/m² · 24 hrs | | 20 |
| Oxygen | ASTM F 1927 | 23° C. 0% RH | cc/m² · 24 hrs | | 1.0 |
| | | 23° C. 50% RH | | | 5.0 |
| Optical: Gloss | ASTM D 2457 | 45° | Units | | 105 |
| Haze (wide angle) | ASTM D 1003 | 2.5° | % | | 5.5 |
| Coefficient of | ASTM D 1894 | Static | | | 0.35 |
| friction (film to film) | | Dynamic | | | 0.30 |
| Tensile strength | ASTM D 882 | | MN/m² | MD | 125 |
| | | | | TD | 70 |
| Elongation at break | ASTM D 882 | | % | MD | 22 |
| | | | | TD | 70 |
| Elasticity modulus | ASTM D 882 | | MN/m² | MD | ≥1200 |
| (1% secant) | | | | TD | ≥600 |
| Sealing range | Manufacturer | 0.5 secs: | ° C. | | 115-170 |
| | Test | 69 kN/m² | | | |
| Sealing strength | Manufacturer | 135° C.; 0.5 secs; | g(f)/25 mm | | 225 |
| | Test | 69 IM/m² | | | |

All properties are tested under standard laboratory conditions: 23±2° C.; 50±5% RH, unless otherwise stated.
Where relevant, tests are based on international testing standards.

### MD—Machine Direction TD—Transverse Direction

Table 2 shows environmental data of NatureFlex™ NK19 according to manufacturer FUTAMURA.

TABLE 2

| | Typical Value/ | Validation or |
|---|---|---|
| Measure | Suitability for use | Test Method |
| Biobased carbon content (¹⁴C) | 91-96% | ASTM D6866 |
| Biomass content (total) | 90% | Futamura calculation |
| Carbon footprint | 5.05 | Peer reviewed LCA 2019 |
| kgCO₂ eq/kg | | GaBi software Impact 2002 + |
| (incl. biogenic) | | (Global warming 500 yr - |
| | | midpoint) |
| Industrial compostability | Certified | EN 13432, EN 14995, AS4736, |
| | | ASTM D6400 and ISO 17088 |
| Home compostability | Certified | OK Compost Home, AS5810 |
| Anaerobic digestion | Approved | ISO 15985 |

NatureFlex™ films are suitable for a range of organic recycling methods, as detailed above, and for incineration with energy recovery. However, they are not designed for mechanical recycling methods. FSC™ certified film is available.

According to the preferred embodiment, the second layer 2 of a bio-based Poly(butylene succinate-co-butylene adipate) (PBSA) is a film made of extrusion of chippings or pellets of PBSA.

PBSA is a combination of 1,4-butane diol, succinic acid, and adipic acid. PBSA is prepared by adding adipic acid to source materials during PBS (Poly(butylene succinate)) synthesis. Although usually synthesized from fossil fuel, it is also possible for the monomers that make up PBSA to be produced from bio-based feedstock. PBSA degrades faster than PBS, has lower crystallinity and is better suited to film applications. The PBSA of the second layer is a bio-based PBSA, is contact food grade, besides compostable. It is preferred that the bio-based PBSA of the second layer is home compostable (OK HOME Compostable-certified).

Properties of bio-based PBSA are shown in Table 3.

TABLE 3

| | | Test | | Bio-based |
|---|---|---|---|---|
| Properties | | Method | Unit | PBSA |
| Density | | ISO 1183 | g/cm³ | 1.24 |
| MFR (190° C., 2.16 kg) | | ISO 1133 | g/10 min | 4 |
| Melting Point | | ISO 3146 | ° C. | 84 |
| Tensile Modulus | MD | ISO 527-3 | MPa | 280 |
| | TD | | | 320 |
| Yield Stress | MD | ISO 527-3 | MPa | 18 |
| | TD | | | 17 |
| Stress at Break | MD | ISO 527-3 | MPa | 32 |
| | TD | | | 27 |
| Strain at Break | MD | ISO 527-3 | % | 600 |
| | TD | | | 580 |
| Elmendorf tear | MD | ISO 6383-2 | N/mm | 2 |
| strength | TD | | | 5 |
| Puncture Impact | | PTTMCC method | kJ/m | 6 |

Manufacturing conditions: B.U.R 2.5, Film thickness 20 μm

According to the same preferred embodiment, the adhesive layer is made of an adhesive commercially known as FlexTack™4G16BIO, an aqueous adhesive based on modified plastic dispersion. Its technical characteristics are:
Appearance: Very low viscosity white liquid
Viscosity: 50-500 mPa·s (Brookfield RVT at 23° C., spindle 1 and 100
rpm).
Solid content: 29-31% approx.
pH: approx. 8.5-10.5
Appearance of dry film: Transparent, shiny and somewhat sticky

Said adhesive has the following applications: Single-component aqueous adhesive for sheet-to-sheet gluing for manufacturing flexible packaging for general uses. Good adhesion on PLA, cellulose diacetate, oxo-degradable and other biodegradable sheets (for example, based on Ecoflex® and Ecovio® polymers). We recommend applying an amount of dry adhesive of approximately 3 g/m².

A 3% addition of FlexTack® Harder-120 increases resistance to heat, water and chemical agents; the mixture of the two components can be used up to 4-5 hours after making it. After physical drying, a calendering between 5° and 80° C. is recommended; immediate handling.

The dry adhesive film is transparent and colorless and has excellent flexibility, it has a very good mechanical stability, with excellent machine behavior, and it has an excellent adhesion on various surfaces.

1. Characterization of Barrier Properties Barrier properties of the food grade multilayer film structure 10 for flexible packaging were measured following the methodology below. Oxygen and water vapour have been considered since they are the most critical specifications could affect the conservation of the product.

### 1.1. Barrier Properties to Oxygen.

Barrier properties were measured according to Oxygen Transmission Rate (OTR) and following the guidelines of ASTM D3985-17 standard. OTR is defined as the amount of oxygen gas passing per unit area of the parallel surfaces of a plastic film per unit of time under a given unit area of the parallel surfaces of a plastic film per unit of time under specified test conditions. The unit in which it is commonly measured is cm³/m²·day.

The oxygen transmission rate (OTR) is determined after reaching equilibrium, in terms of temperature and relative humidity (RH), of the environment in which the sample is placed. A dry environment is the one in which the RH is below 1% and a controlled RH environment is the one in which the RH is within 35-90%. In this case, the selected conditions were 50% of RH at a temperature of 23° C., similar to the expected conditions of use of the materials. The samples were measured using an OX-TRANS Model 2/21 (Mocon).

The sample is placed in each cell under atmospheric pressure. As shown in FIG. 2, a carrier gas (N₂ 98%, H₂ 2%) passes by one side of the cell and, by the opposite side of the cell, the test gas flows (O₂ 99.95% purity). The oxygen that passes through the cell is collected by the carrier gas, to carry it to a coulometric sensor which produces an electric current. This current is proportional to the oxygen quantity which flows to the detector per time unit.

In the case of the flexible part of the pouch, the film can be measured directly.

Specifically, a 12.636 cm² area is prepared for each sample to carry out measurements by cutting them with a hole puncher (FIG. 3—left). Then, they are masked up to 4.941 cm² with aluminium sealing masks (FIG. 3—right) and lastly, thickness of each sample is registered (at least 5 different measurements are taken).

The sample is placed in the cell, adjusting temperature and relative humidity control, and the flow of gases is established. The equipment can be programmed to measure in different ways:
continuously: it is necessary to stop it manually.
standard: a determined number of cycles is selected by the user.
convergence by cycles: the equipment consider that the equilibrium has been reached when 2 values differ by less than 1% of 0.05 cm³/m²·day (whichever is bigger) in a determined number of cycles.
convergence by hours: the equipment consider that the equilibrium has been reached when 2 values differ by less than 1% of 0.05 cm³/m²·day (whichever is bigger) in a determined number of hours.
Once the measurement is finished, the value of OTR can be extracted from the equipment for each sample measured. At least 2-3 samples of each reference are measured, and the average value and deviation are calculated.

### 1.2. Barrier Properties to Water Vapour

Barrier properties are measured according to Water Vapour Transmission Rate (WVTR) and following the guidelines of ASTM F1249-13 standard, using the units g/m²·day. The methodology is the same followed in the determination of the oxygen barrier.

The measurement conditions are more restrictive in this case, a temperature of 38° C. and RH of 90% are selected. The equipment is Permatran W 3/33 SG+ (Mocon).

Once the measurement is finished, the value of WVTR can be extracted from the equipment for each sample measured. At least 2-3 samples of each reference are measured, and the average value and deviation are calculated.

### 2. Characterization of Mechanical Properties.

Mechanical properties as the tensile resistance, resistance to puncture, tear and delamination were evaluated, and, finally, the coefficient of friction (COF) to predict its behavior in the process of forming the pouch.

### 2.1. Tensile Resistance.

The aim of this test is to determine the resistance of a material when is subjected to an axial tensile stress, following the directions of the ISO 527-1 standard. It consists of applying an increasing stress to a standardised test probe, with respect to its longitudinal axis, until it breaks. This effort is applied at constant speed and the force applied and elongation of the sample are continuously measured.

It is possible also to obtain test probes from a film by cutting it with standardized dimensions, 100 mm of length and 15 mm of width, making sure that the thickness is homogeneous along the entire test probe.

The speed test is selected according to the material, considering the tolerance set by the standard.

Before the test, the samples must be conditioned at the conditions set by the standard during at least 16 h. The recommended conditions are a temperature of (23±2)° C. and relative humidity of (50±10)%.

The equipment employed is a Testometric M350-20CT, shown in FIG. 4.

### 2.2. Puncture Resistance.

This test method permits flexible barrier films and laminates to be characterized for slow rate penetration resistance to a driven probe and it is regulated by the ASTM F1306-16 standard. The test is performed at room temperature, by applying a biaxial stress at a single test velocity on the material until perforation occurs. The force, energy, and elongation to perforation are determined.

Penetration resistance is an important end-use performance of thin flexible materials, where a sharp-edged product can destroy the integrity of a barrier wrap. Material response to penetration will vary with numerous factors, such as film thickness, elastic modulus, rate of penetration, temperature, shape and type of probe. Consequently, material responses from puncture to stretch may be observed and quantified using this method. Although numerous combinations of experimental factors can be devised and used to simulate specific end-use applications, the recommended conditions in this method should be followed for standard comparisons of materials.

A 3.2 mm diameter hemispherical (biaxial stress) penetration probe is recommended for general application and comparison of materials and interlaboratory results. A sample test diameter of 34.9 mm is required for interlaboratory comparison of results. If other probes are used, a minimum clamp to probe diameter ratio of 10 to 1 is required.

The test probes must have dimensions of 76×76 mm and the thickness needs to be as homogeneous as possible (maximum deviation is ±2% or 0.0025 mm, whichever is larger). They need to be conditioned at (23±2)° C. and relative humidity of (50±10)% for not less than 24 h. The test shall be conducted at the same temperature and RH, unless different conditions are specified because of the nature or end use of the material.

To perform the test, the film must be clamped in the holder and centred and the penetration probe must be lower as close as possible to film, avoiding making contact. Then, the speed is selected, 25 mm/min, and also the data acquisition rate, to give a minimum resolution of 0.1 mm/point of penetration. The test starts and it is considered finished when the first sign of perforation is detected.

The parameters recorded during the test are force (peak) to break, energy (work) to break, and probe penetration (at first break). A minimum of 5 test probes needs to be measured for each reference analysed.

### 2.3. Tear Resistance.

This test is also known as trouser tear method and is regulated by the ISO 6383-1 standard. This method is suitable for determining the tear resistance of films and sheets of less than 1 mm of thickness. It can be applied to flexible and rigid materials, if they are not so stiff that brittle fracture occurs during the test or that they deform irreversibly, being this deformation energy greater than the tearing energy.

The samples are cut to the shape determined by the standard (similar to a trouser), making a fissure in the center. The length of this fissure must be 75±1 mm and the edges need to be soft and without any imperfections. Once they are prepared, they must be conditioned at (23±2)° C. and relative humidity of (50±10)%.

The test direction is the longitudinal of the sample and the recommended speed is (200 mm/min)±10%. Before starting the test, the thickness of the samples must be measured at three equidistant points between the fissure and the opposite side of the test probe. The distance between the clamps is set at 75 mm and the “trouser legs” are aligned with the clamps so that its main axis is positioned in an imaginary line that join both clamps. The test starts at the speed selected, recording the load required to propagate the tear through the uncut length. The test must be discarded if the tear deviates from the center and reaches the edge of the sample.

Tear resistance is calculated by considering the force applied divided by the thickness of the test probe.

### 2.4. Bond Strength of Laminates.

This test method is regulated by the ASTM F904-16 standard and aims to compare the bond strength or ply adhesion of similar laminates made from flexible materials. This includes laminates made by various processes: adhesive laminates, extrusion coatings, extrusion laminates, and coextrusion. The method can be used to compare bond strength of similar materials and to study changes under different conditions of end use.

The test probes are prepared by cutting strips 25 mm wide and about 250 mm long. They must be clean and have uniform edges to avoid any interferences in the results of the test. At least 5 samples must be tested in longitudinal (machine) direction, testing transverse direction only for special purposes. As in the previous tests, the sample must be previously conditioned at (23±2)° C. and relative humidity of (50±10)%, ideally for 40 h.

The equipment used is a typical tensile testing machine. First of all, it is necessary to set full-scale load, so that most test specimen scans fall in the center two thirds of the chart and draw speed at 280 mm/min±10%.

The delamination process must be initiated by an external stimulate. It can be done manually, if it is possible, or by the application of heat or by using a solvent. The separated plies of the test probe are placed into the grips of a tensile testing machine, setting a distance between them of 25.4 mm. The grips are then separated and the force required to further separate them is defined as bond strength.

### 2.5. Coefficient of Friction

This parameter is determined by the method described in the ISO 8295-05 standard. It can be applied to determine the coefficient of friction static and dynamic of plastic films when they slide on themselves or on other materials, such as metal. The films tested must be non-adhesive ones and have a maximum thickness of 0.5 mm. It should be noted that this parameter is only indicative of the final behaviour of the material in the machine, since other factors such as electrostatic charges, temperature or abrasion may affect its performance.

The test must be performed on a horizontal and smooth table, using a sleigh as mobile part and a driving mechanism. This sleigh should have a square shape with a surface area of 40 cm² and total weigh of 200±2 g, applying a normal force of 1.96±0.02 N. To ensure that the pressure applied is uniform, the base of the sleigh mush be covered with an elastic material (such as felt). The samples must be conditioned at 23*2)° C. and relative humidity of (50*10)% for at least 16 h and to fix them to the table an adhesive tape can be used.

The contact surfaces are placed together in a plane in contact and under uniform contact pressure. The normal force is applied by the sleigh and the slide speed should be between 100 and 500 mm/min. The test should not last more than 0.5 s.

The coefficient of friction is calculated as the ratio of the normal force to the frictional force, with both being applied perpendicular to the two contact surfaces.

### 3. Test Results of Characterization of Barrier and Mechanical Properties

A particular embodiment of the laminate, that is to say, the multilayer film structure 10 according to the present invention, was tested according to what has been explained above. In said embodiment, the first layer was made of the cellulose-based barrier film that is commercially known as NatureFlex™ 19NK, with a thickness of 19 μm; the second layer was made of the bio-based PBSA with properties in Table 3, with a thickness of 84 μm, and said layers were joined by an adhesive commercially known as FlexTack™ 4G16 BIO.

The following Table 4 shows the control values obtained in the characterization of the barriers (OTR and WVTR) and of the mechanical properties (puncture, tear and dynamic COF) of the materials separately (NK19 and bio-based PBSA) as well as the resulting laminate of the multilayer film structure according to the embodiment previously disclosed:

TABLE 4

| | OTR | WVTR | Puncture | Tear | Dynamic COF |
|---|---|---|---|---|---|
| | cm³/m² · | g/m² · | resistance, | resistance, | (plastic vs. |
| | day | day | N | N | metal) |
| 2^{nd} layer | 508 | 121 | 9.36 ± 0.60 | 13.96 ± 2.40 | 0.383 ± 0.016 |
| bioPBSA | | | | | |
| 1^{st} layer | 5 | 20 | 9.63 ± 0.76 | 0.418 ± 0.156 | 0.339 ± 0.007 |
| Laminate | 6.05 ± 0.11 | 10.79 ± 0.67 | 14.10 ± 1.10 | 11.03 ± 1.69 | 0.341 ± 0.016 |

It is highly relevant that the resulting laminate offers better WVTR (water vapor) barriers than each of the 1^{st} or 2^{nd} layer alone—the lower the number, the better. Puncture and tear resistance have also improved. Further tests were performed to obtain the following properties (Table 5):

TABLE 5

| | |
|---|---|
| Young Modulus (Gpa) | 1.34 ± 0.07 |
| Elongation at break (%) | 17.46 ± 1.15 |
| Resistance to delamination (N/mm) | 0.108 ± 0.005 |

### 4. Test Showing the Suitability of the Laminate for Containing Semi-Liquid Products

Tests were performed as evidence that the multilayer structure is suitable for packaging or flexible containers (such as doypacks or pouch-like containers) to contain semi-liquid food products. This is the case, for instance of the values of the barriers of OTR (to oxygen) and WVTR (to water vapor) obtained. Packaging tests with a semi-liquid product (see description of semi-liquid and characteristics below), namely sports energy gels, have been carried out with the NK+bio-based PBSA film and the results are that the material has withstood packaging and contact with the tested energy gels for at least 12 months without undergoing modifications or alterations in its composition.

“Semi-liquid products” means food products which have a consistency between liquid and solid, and are characterized by all the following features:
having a variable rheological behavior and viscosity of 500 cp to 3000 cp (mPa·s) at room temperature (Brookfield DBII 10 rpm spindle 4)
product with a carbohydrate content greater than sixty percent (60%)
product with a water content of less than thirty percent (30%)
the product's packaging does not require sterilization through pasteurization.

### 4.1. Forming Process

In order to simulate the filling process of a pouch in an industrial environment, laboratory-scale trials were carried out. A simple design of rectangular “bag” shape was obtained. For the first trials performed the dimensions selected were 15×10 cm, reducing to 12×6 cm in the last trials.

The laminated structure was cut to the selected dimensions in each case and sealed with a laboratory heat sealer. Three sides of the bag were sealed, leaving one of the narrower sides open. Different sealing conditions were tested, setting the temperature to 130° C., a pressure of 44 psi for 0.8 s.

### 4.2. Filling Process

The structures developed following the methodology described in the previous section were filled with different semi-liquid products, specifically five different formulations of sports energy gels. A syringe was employed to introduce the sport gels in the bag, avoiding any contact with its edge. Once the gel was inside the bag, the open side was carefully cleaned to ensure that there was no trace of product on the edge that could affect the sealing process.

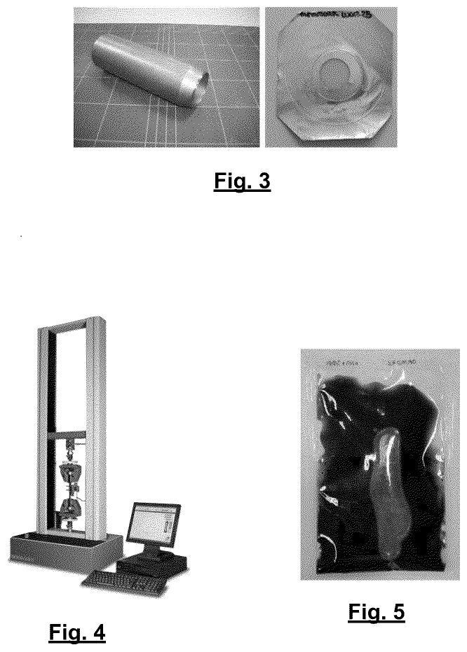

Finally, the open side was sealed following the conditions selected in the forming step. The packaged products were stored under ambient conditions. The appearance of the structure was visually checked over several weeks in order to verify that there was not any change which could compromise the conservation of the product. Below some examples of formed and filled structures are shown, FIG. 5 corresponds to the last batch.

### 5. Method of Manufacturing the Laminate (Multilayer Film Structure 10)

The description of the processing techniques and processing parameters optimized for each material are shown in the next section as an example of performance. However, it must be taken into account that other non-disclosed processing techniques are also suitable. For instance, instead of co-extruding in plane (disclosed in section 5.1), the extrusion could be made by blow extrusion.

### 5.1. Processing of the Base Film

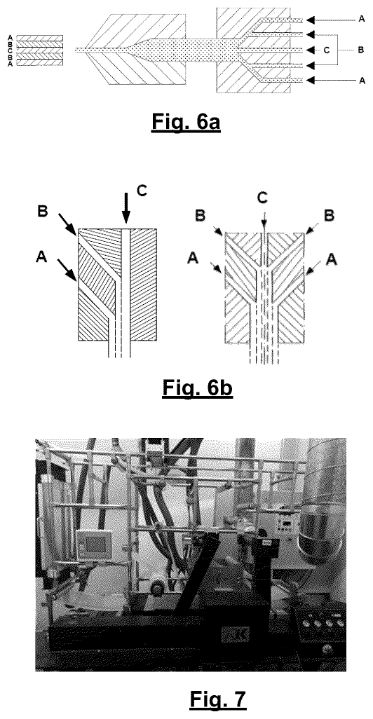

The monolayer film based on BioPBS™ FD92PM (PBSA) was processed at pilot scale using a Dr Collin cast co-extrusion line. This co-extrusion line is based on three single screw extruders (E30P, 25 LID), connected to a feedblock and a variable thickness flexible lip die. The unit has a feed-block that can provide up to five layers (ABCBA), as well as different multilayer rearrangements (ABC, BCB, ACA), bilayer (AC, BC), or monolayer structures as is shown in FIGS. 6a and 6b. FIG. 6a shows the feed-block and die flow, whereas FIG. 6b shows a possible structure arrangement (3 non-symmetrical and 5 symmetrical structures).

The flat sheet die has 500 mm width, and a variable thickness from 0.3-1.3 mm, that can be adjusted based on desired final thickness of the film. The calender design is based on a central temperature controlled fixed roll, and a side adjustable smoothing roll that can be moved hydraulically. Using a fine adjustment of the gap, it is possible to smooth webs, to calender film or to produce laminates.

An air knife can be used to improve film clarity and gloss. A streamline jet of filtered air coming from the air knife impinges on the film just beyond the point of first contact with the chill roll and presses it against the roll.

The roll cooling stack can be positioned both horizontal and vertically. This helps to control the air gap. This distance covered from the die exit to the point where the film contacts the chill roll, and control drawdown ratio, cooling and shrinkage. The chill roll drive speeds are very precisely regulated to control film draw-down and finished thickness. The film is drawn with the fixed roll, controlling line speed and torque. Trimming the edges can be performed online using edge trimmers and trims are automatically wound on reels. This line resembles processing parameters on an industrial line, providing all required data for subsequent upscaling.

Preliminary trials were carried out to adjust processing parameters using bio-based PBSA polymer. These conditions were considered as start-up conditions to carry out the processing trials for further development of the film. Processing was carried out using one extruder (C) to obtain a single layer structure.

During the extrusion process, screw speed and temperatures were adjusted to provide required film width and layer thickness. Screw speed represents a major parameter for extruder output. For efficient machine operation and comparatively high output from a given machine, the screw should be run as fast as possible without representative fluctuations of pressure, and also to minimise the residence time to prevent polymer hydrolysis.

Film width was adjusted controlling air gap, whereas thicknesses is related mainly to the screw speed (output) and take off speed. During trials, thickness deviations were adjusted by means of die screws, obtaining values lower than 5% deviation on required thickness across film width.

During processing, temperature profile on the extruder, transfer lines, feed-block and die were established, being below degradation temperature of materials. These processing conditions were stable and reproducible and are shown in Table 6 of processing parameters of the bio-based PBSA film obtained by cast extrusion.

TABLE 6

| | EXT C | | Die |
|---|---|---|---|
| | (° C.) | | (° C.) |
| Inlet | 40 | Coex 1 | 200 |
| Cylinder 1 | 190 | Coex 1 | 200 |
| Cylinder 2 | 195 | Die 1 | 195 |
| Cylinder 3 | 195 | Die 2 | 195 |
| Cylinder 4 | 200 | Die 3 | 195 |
| Cylinder 5 | 200 | Upper lip | 190 |
| Adapter 1 | 200 | Lower lip | 190 |
| Screw r.p.m. | 100 | | |

| Flat film | |
|---|---|
| Chill roll (m/min) | 3.4 |
| Take off (%) | 0.9 |
| Winder (%) | 52 |
| Pressure (bar) | 132 |
| Thickness (μm) | 85 |
| Width (cm) | 47 |

### 5.2. Processing of the Bilayer Structure

The final structure of the flexible part of the pouch is made of the film processed based on a bio-based PBSA (the one with properties in Table 3), the commercial film Natureflex™ NK19, and a compostable adhesive, FLEXTACK™ 4G16BIO, to join both materials. This structure was developed by lamination in a semi-industrial laminating machine RK (FIG. 7).

This is a “roll to roll” process in which the substrate 1 (bio-based PBSA) is placed in the unwinding section and by means of a disposition of different rolls, it passes through the adhesive application section. In this case, it was applied by means of rotogravure technology using a 26LCM anilox roller with a theoretical volume of 45 cm³/m².

The grammage of adhesive FLEXTACK™ 4G16810 applied with this anilox roller was around 3 g/m². To determine this value, the quantity of solids of the adhesive (31%) and the wet quantity applied by this anilox (18 g/m²) were considered.

Once the adhesive was applied on the substrate (˜3 g/m²), the material was dried by passing it through two hot air ovens (50° C.) to dry the adhesive sufficiently to obtain adequate adhesion to the second substrate, Natureflex™ NK19, and, subsequently, to achieve good adhesion between the two substrates. This second substrate was placed on the second unwinding section and was brought to the treader/laminator roller by means of different rollers. The two substrates were bonded together into a single bilayer laminated structure in this laminator roller. This roller, due to the characteristics of the adhesive, was heated to a temperature about 75° C. in order to achieve the maximum adhesion.

Afterwards, the processing trials at industrial scale of this flexible structure, F-01, were performed successfully.

1. A food grade multilayer film structure for manufacturing flexible containers or flexible parts of containers for dry to semi-liquid products, comprising:
a first layer of a cellulose-based barrier film with a thickness between 17 and 23 μm;
a second layer of a bio-based Poly(butylene succinate-co-butylene adipate) (PBSA) with a thickness between 80 and 85 μm; and
an adhesive layer joining the first layer and the second layer wherein the multilayer film structure is a compostable according to the European standard EN 13432.

2. The food grade multilayer film structure according to claim 1, wherein the first layer has a thickness between 18.8 and 19.4 μm, and the second layer has a thickness of 84 μm.

3. The food grade multilayer film structure according to claim 1, having an Oxygen Transmission Rate (OTR) between 5.94 and 6.17 cm3/m2·day at 23° C. and 50% relative humidity over 24 hours according to the guidelines of ASTM D3985-17 standard, and a Water Vapour Transmission Rate (WVTR) between 10.12 and 11.46 g/m2·day at a temperature of 38° C. and 90% of relative humidity according to the guidelines of ASTM F1249-13 standard.

4. The food grade multilayer film structure according to any claim 1, having a puncture resistance of 14.10±1.10 N, and a tear resistance of 11.03±1.69 N.

5. The food grade multilayer film structure according to any claim 1, having a Young Modulus of 1.34±0.07 Gpa.

6. The food grade multilayer film structure according to claim 1, having an elongation at break of 17.46±1.15%.

7. The food grade multilayer film structure according to claim 1, having a resistance to delamination of 0.108±0.005 N/mm.

8. The food grade multilayer film structure according to claim 1, having a dynamic coefficient of friction (COF) of 0.341±0.016 according to ISO 8295-05 standard.

9. The food grade multilayer film structure according to claim 1, wherein the second layer of a bio-based Poly(butylene succinate-co-butylene adipate) (PBSA) is home compostable.

10. The food grade multilayer film structure according to claim 1, wherein the multilayer film structure is home compostable.

11. The food grade multilayer film structure according to claim 1, wherein the first layer of a cellulose-based barrier film is made of a transparent cellulose film provided with an upper moisture barrier heat-seal coating and a lower moisture barrier heat-seal coating, having an Oxygen Transmission Rate (OTR) about 5.0 cc/m2·day at 23° C. and 50% relative humidity over 24 hours according to the guidelines of ASTM F 1927 standard, and a Water Vapour Transmission Rate (WVTR) about 20.0 g/m2·day at a temperature of 38° C. and 90% of relative humidity according to the guidelines of ASTM E96standard.

12. A method of manufacturing a flexible container or a flexible part of a container for dry to semi-liquid products comprising using the food grade multilayer film structure of claim 1, wherein the first layer of a cellulose-based barrier film is the inner layer to be in contact with a semi-liquid food product, and the second layer of a bio-based Poly(butylene succinate-co-butylene adipate) (PBSA) is the outer layer of the flexible container.

13. A flexible container or a flexible part of a container, for dry to semi-liquid products made of the food grade multilayer film structure of claim 1, wherein the first layer of a cellulose-based barrier film is the inner layer to be in contact with a dry to semi-liquid product, and the second layer of a bio-based Poly(butylene succinate-co-butylene adipate) (PBSA) is the outer layer of the flexible container or of the flexible part of a container.

14. A flexible container according to claim 13, wherein the flexible container is a stand-up pouch.

15. The food grade multilayer film structure according to claim 1, wherein the first layer has a thickness of 19.0 μm, and the second layer has a thickness of 84 μm.
